(19) United States
(12) Patent Application Publication
(10) Pub. No.: US 2026/0236656 A1
(43) Pub. Date: Aug. 13, 2026

(54) IR OPTIMIZATION TECHNIQUE OF INTEGRATED CIRCUIT LAYOUT

(71) Applicant: TAIWAN SEMICONDUCTOR MANUFACTURING COMPANY LTD., HSINCHU (TW)

(72) Inventors: YU-WEN LIN, HSINCHU CITY (TW); WEI-CHIH HSIEH, TAOYUAN CITY (TW); FLORENTIN DARTU, AUSTIN, TX (US)

(21) Appl. No.: 19/050,141

(22) Filed: Feb. 11, 2025

(51) Int. Cl. G06F 30/3312; G01R 31/319

(52) U.S. Cl. CPC G06F 30/3312; G01R 31/31922; G01R 31/31924

(57) ABSTRACT

The present disclosure provides a method. The method includes the following steps: identifying a target timing margin needed by a device under test (DUT) within an integrated circuit (IC) design; in response to the DUT being unable to be boosted to reduce a timing slack thereof, performing a timing slack extraction operation on fan-in devices and fan-out devices of the DUT; in response to an unsuccessful boosting operation of a selected device, updating an IC layout diagram of the IC design by replacing a first instance with a first timing slack currently used by the selected device with a second instance with a second timing slack, wherein the second timing slack is greater than the first timing slack; and repeatedly performing the timing slack extraction operation on the fan-in devices and the fan-out devices until the target timing margin is met.

### BACKGROUND

IR optimization in integrated circuit (IC) design refers to the process of minimizing voltage drop (IR drop) and ensuring reliable power delivery across the chip. “IR” stands for current (I) and resistance (R), and the term “IR drop” describes the voltage drop that occurs when current flows through the resistive elements of the power distribution network in an IC. This voltage drop can lead to insufficient power supply to certain parts of the chip, potentially causing performance degradation or functional failures.

### BRIEF DESCRIPTION OF THE DRAWINGS

Aspects of the present disclosure are best understood from the following detailed description when read with the accompanying figures. It is emphasized that, in accordance with standard practice in the industry, various features are not drawn to scale. In fact, the dimensions of the various features can be arbitrarily increased or reduced for clarity of discussion.

FIG. 1 is a block diagram of an IC design system 100 in accordance with some embodiments.

FIG. 2 is a diagram illustrating a device under test (DUT) and its fan-in and fan-out devices in accordance with some embodiments of the present disclosure.

FIGS. 3A to 3C are diagrams illustrating the timing slack extraction (ETS) procedure of a DUT in accordance with some embodiments of the present disclosure.

FIG. 4 is a flowchart of a method for IR drop optimization of an IC design in accordance with some embodiments of the present disclosure.

FIG. 5 is a flowchart of a backend IC design flow in accordance with some embodiments of the present disclosure.

FIG. 6 is a block diagram of an IC manufacturing system, and an IC manufacturing flow associated therewith, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features can be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “over,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Further, it will be understood that when an element is referred to as being “connected to” or “coupled to” another element, it can be directly connected to or coupled to the other element, or intervening elements can be present.

Embodiments, or examples, illustrated in the drawings are disclosed as follows using specific language. It will nevertheless be understood that the embodiments and examples are not intended to be limiting. Any alterations or modifications in the disclosed embodiments, and any further applications of the principles disclosed in this document are contemplated as would normally occur to one of ordinary skill in the pertinent art.

Further, it is understood that several processing steps and/or features of a device can be only briefly described. Also, additional processing steps and/or features can be added, and certain of the following processing steps and/or features can be removed or changed while still implementing the claims. Thus, it is understood that the following descriptions represent examples only, and are not intended to suggest that one or more steps or features are required.

In addition, the present disclosure may repeat reference numerals and/or letters in the various examples. This repetition is for the purpose of simplicity and clarity and does not in itself dictate a relationship between the various embodiments and/or configurations discussed.

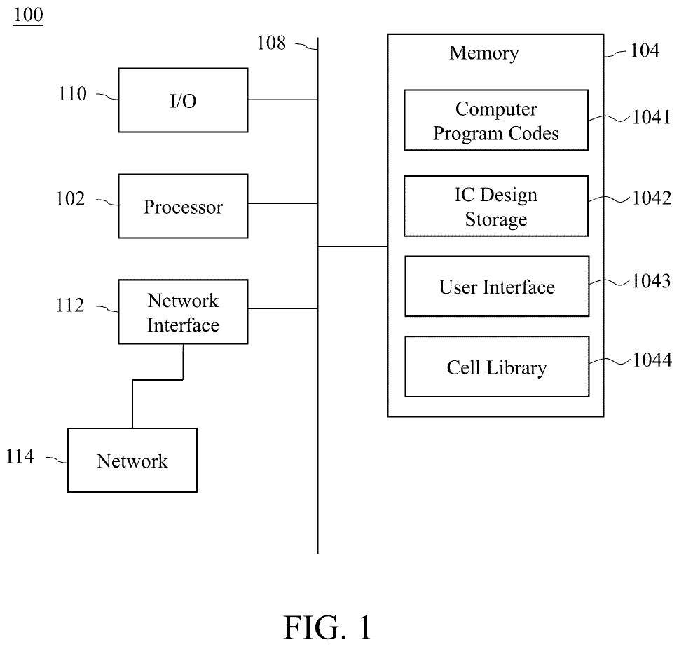

FIG. 1 is a block diagram of an IC design system 100 in accordance with some embodiments. Methods described herein for designing IC layout diagrams and adaptively generating power delivery networks in accordance with one or more embodiments are implementable, for example, using IC design system 100, in accordance with some embodiments.

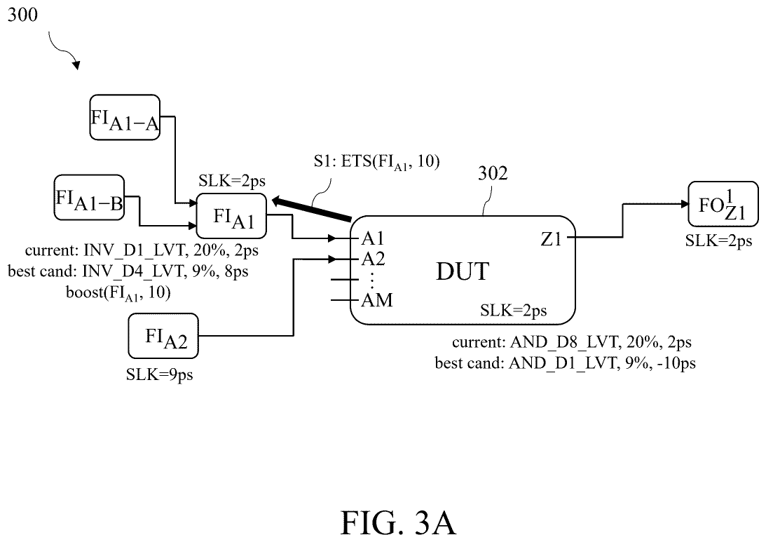

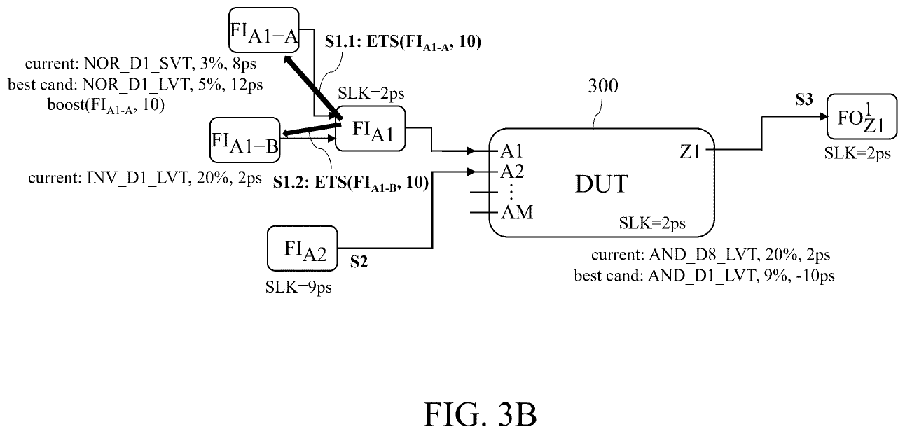

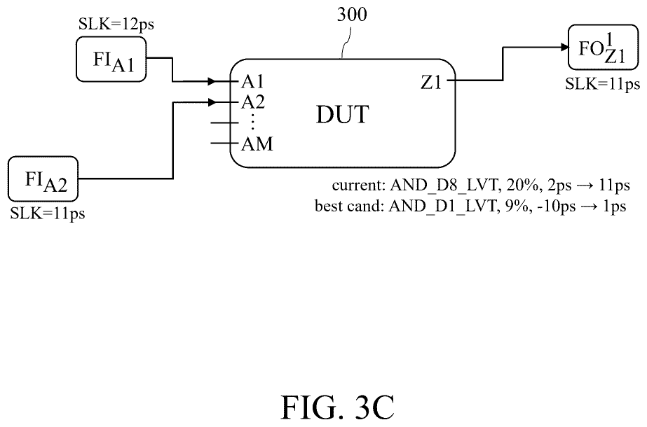

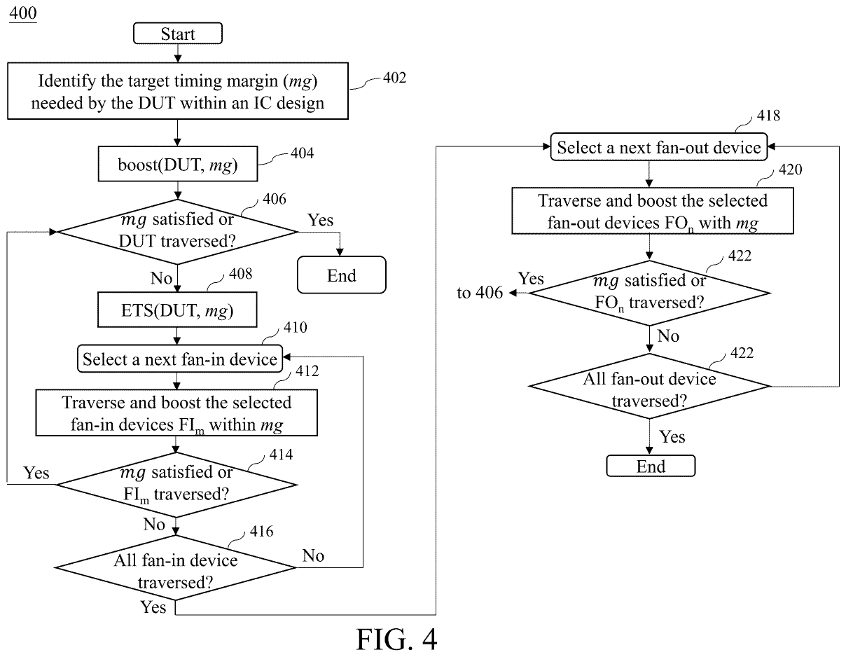

In some embodiments, IC design system 100 is a general purpose computing device including a hardware processor 102 and memory 104. Memory 104 is a non-transitory, computer-readable storage medium. Memory 104, amongst other things, is encoded with, i.e., stores, computer program codes 1041, i.e., a set of executable instructions. Execution of computer program codes 1041 by hardware processor 102 represents (at least in part) an EDA tool which implements a portion or all of a method or flow shown in FIGS. 3 to 4 described later (hereinafter, the noted processes and/or methods). In one or more embodiments, memory 104 includes IC design storage 1042 configured to store one or more IC design schematics or netlists.

Processor 102 is electrically coupled to memory 104 via bus 108. Processor 102 is also electrically coupled to an I/O interface 110 through bus 108. Network interface 112 is also electrically connected to processor 102 through bus 108. Network interface 112 is connected to a network 114, so that processor 102 and memory 104 are capable of connecting to external elements via network 114. Processor 102 is configured to execute computer program codes 1041 encoded in memory 104 in order to cause IC design system 100 to be usable for performing a portion or all of the noted processes and/or methods. In one or more embodiments, processor 102 is a central processing unit (CPU), a multi-processor, a distributed processing system, an application specific integrated circuit (ASIC), and/or a suitable processing unit, but the present disclosure is not limited thereto.

In one or more embodiments, memory 104 is an electronic, magnetic, optical, electromagnetic, infrared, and/or a semiconductor system (or apparatus or device). For example, memory 104 may be or include a non-volatile memory such as a semiconductor or solid-state memory, a hard disk drive (HDD), a magnetic tape, a removable computer diskette, a random access memory (RAM), a read-only memory (ROM), a rigid magnetic disk, an optical disk, SD memory card, memory sticks, ferroelectric random access memory (FeRAM), resistive random access memory (RRAM), etc., but the present disclosure is not limited thereto. In one or more embodiments using optical disks, memory 104 includes a compact disk-read only memory (CD-ROM), a compact disk-read/write (CD-R/W), and/or a digital video disc (DVD).

In one or more embodiments, memory 104 stores computer program codes 1041 configured to cause IC design system 100 (where such execution represents (at least in part) the EDA tool) to be usable for performing a portion or all of the noted processes and/or methods. In one or more embodiments, memory 104 also stores information which facilitates performing a portion or all of the noted processes and/or methods.

IC design system 100 includes I/O interface 110. I/O interface 110 is coupled to external circuitry. In one or more embodiments, I/O interface 110 includes a keyboard, keypad, mouse, trackball, trackpad, touchscreen, and/or cursor direction keys for communicating information and commands to processor 102.

In some embodiments, IC design system 100 also includes network interface 112 coupled to processor 102. Network interface 112 allows IC design system 100 to communicate with network 114, to which one or more other computer systems are connected. In some embodiments, network interface 112 includes wireless network interfaces and/or wired network interface. The wireless network interface may include Wi-Fi (802.11), Global System for Mobile Communications (GSM), Enhanced Data rates for GSM Evolution (EDGE), Wideband Code Division Multiple Access (WCDMA), Time Division-Synchronous Code Division Multiple Access (TD-SCDMA), Long Term Evolution (LTE), 4-th Generation (4G), 5-th Generation (5G), 6-th Generation (6G), ultra-wideband (UWB), infrared (IR) protocols, near field communication (NFC) protocols, Wibree, Bluetooth protocols, wireless Universal Serial Bus (USB) protocols, etc. The wired network interfaces may include Ethernet, Universal Serial Bus (USB), Inter Integrated Circuit (I2C), Serial Peripheral Interface (SPI), etc., but the present disclosure is not limited thereto. In one or more embodiments, a portion or all of noted processes and/or methods, is implemented in two or more IC design systems 100.

In some embodiments, IC design system 100 is configured to receive information through I/O interface 110. The information received through I/O interface 110 includes one or more of instructions, data, design rules, libraries of standard cells, and/or other parameters for processing by processor 102. The information is transferred to processor 102 via bus 108. IC design system 100 is configured to receive information related to a user interface through I/O interface 110. The information is stored in memory 104 as user interface (UI) 1043.

Cell library 1044 may include one or more cell libraries each storing schematics of a plurality of cells that can be used in a pre-layout simulation process. For example, a cell may refer to a standard cell, an analog cell, a memory cell (e.g., SRAM bit cell), an input/output (I/O) cell, or the like. In some embodiments, each standard cell may be a macro including one or more transistors. Examples of a macro including one logic gate can be an NOT, AND, OR, NAND, NOR, XOR gate, etc. In some embodiments, each cell in the cell library includes a plurality of logic gates. Examples of a macro including plural logic gates or a CMOS complex gate can be a 2-bit full adder, a D flip-flop, a latch, a buffer, and-or-invert gate (AOI), or-and-inverter gate (OAI), etc.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application. In some embodiments, at least one of the noted processes and/or methods is implemented as a software application that is a portion of an EDA tool. In some embodiments, a portion or all of the noted processes and/or methods is implemented as a software application that is used by IC design system 100.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

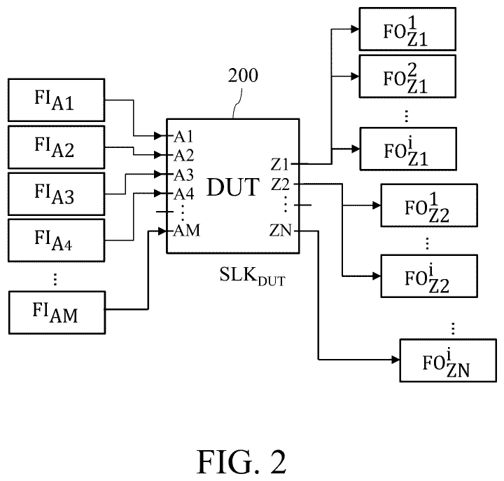

FIG. 2 is a diagram illustrating a device under test (DUT) and its fan-in and fan-out devices in accordance with some embodiments of the present disclosure.

In some embodiments, the DUT 200 may be an instance with M inputs (e.g., A1 to AM) and N outputs (e.g., Z1 to ZN), where M and N are positive integers. An instance may refer to a specific occurrence of a standard cell, a circuit module, or a circuit component within an integrated circuit (IC) design. In some embodiments, a standard cell may consist of one or more standard threshold voltage (SVT), low threshold voltage (LVT), ultra-low threshold voltage (ULVT), extreme-low threshold voltage (ELVT), or high threshold voltage (HTV) devices, but the present disclosure is not limited thereto.

As depicted in FIG. 2, a plurality of fan-in devices FI_{A1} to FA_{M1} are connected to the input ports A1 to AM of the DUT 200. Additionally, FI_{Am} represents the m-th fan-in device connected to the m-th input port of the DUT 200, where m is a positive integer between 1 and M. It should be noted that part of the fan-in devices FI_{A1} to FI_{AM} may also have their respective fan-in devices (not shown in FIG. 2). Furthermore, each output port Z1 to ZN may drive one or more fan-out devices FO. For example,

$${FO}_{Zn}^{i}$$

refers to the i-th fan-out device connected to the n-th output port Zn, as depicted in FIG. 2.

Additionally, SLK_{DUT} represents the slack (e.g., also referred to as slack time or timing slack) of the DUT 200, which can be reported by the EDA tool (e.g., timing analysis tool). In some embodiments, the DUT 200 may include one or more standard cells, each with timing information (e.g., setup time, hold time, and the like) recorded in a respective library file (e.g., .lib file) within the cell library 1044. The static timing analysis (STA) tool can obtain the timing information from the respective library file of each standard cell within the DUT 200, thereby calculating the slack of the DUT 200. More specifically, “slack” (e.g., abbreviated as SLK) represents the difference between the required arrival time (RAT) and the actual arrival time (AAT) of a signal at a timing endpoint. RAT is the latest time that a signal can arrive at a destination without violating the timing constraint, while AAT is the time that a signal actually arrives at a destination based on the delay of the logic and interconnect paths. Slack can be positive, negative, or zero. Positive slack means that the signal arrives earlier than required, negative slack means that the signal arrives later than required, and zero slack means that the signal arrives exactly as required.

For purposes of description, “mg” represents the timing margin required to size down the DUT 200 for fixing IR violation. For brevity, the DUT 200 can be implemented using a specific standard cell. Upsizing the DUT 200 or swapping one or more standard cells or devices therein with a higher threshold voltage (e.g., threshold-voltage up-swapping method) may help to reduce the slack of the DUT 200. Here, upsizing the DUT 200 indicates that increasing the device size or transistor size of the standard cell in the automatic placement-and-routing (APR) procedure or replacing the specific standard cell with another standard cell with the same function and a larger transistor size. It should be noted that the device size or transistor size may refer to the channel width for planar field-effect transistor devices, the number of fins for finFETs, or the number of channels or nanosheets for nanosheet FETs. In some embodiments, the threshold-voltage up-swapping method may indicate that a standard cell of the same function but with a higher threshold voltage is used to replace the DUT or fan-in/fan-out device. For example, if the DUT is a low-threshold voltage (LVT) device, it can be replaced by a standard-threshold voltage (SVT) device of the same function to improve the timing slack of the DUT.

In some embodiments, in order to perform JR optimization, a recursive function ETS and a “boost” function are introduced. The ETS function is a recursively called function configured to gain target timing margin mg on the DUT and its fan-in and fan-out devices, while the boost function may be configured to speed up the DUT with a target timing margin and ensure that the sped-up DUT satisfies the timing requirement without JR violation. The ETS function and the boost function can be expressed using the following pseudo codes in Table 1.

TABLE 1
Pseudo Codes

| | |
|---|---|
| func boost (DUT, mg) { | ## create slack |

```
  upSize/upVtSwap DUT to let SLK_{DUT} closed to mg without timing/IR violation
  tvl[DUT] == 1
}
```

| | |
|---|---|
| func ETS (DUT, mg) { | ## define recursive function |

```
  if (SLK_{DUT} >= mg or tvl[DUT] == 1) { return }
  for each cell in [every DUT's fanin and fanout] {
    boost (cell, mg)
    ETS (cell, mg)
  }
}
Main( ) {
```

| | |
|---|---|
| tvl[*] = 0 | ## initialize all instance as not traveled |
| tvl[not FI/FO of DUT] = 1 | ## flag none FI/FO of DUT as traveled |
| ETS (DUT, mg) | ## extract timing slack for DUT with target mg slack |
| } | |

It should be noted that the pseudo codes in Table 1 can be used for a digital IC which includes one or more DUTs. Referring to Table 1, the main program Main( ) is configured to perform the initialization procedure. The main program Main( ) may initialize all instances (e.g., including the DUTs and their fan-in/fan-out devices, and non-fan-in/fan-out devices) as not traversed (e.g., tvl[*]=0), label the none fan-in/fan-out devices of the DUT as traversed (e.g., tvl[not FI/FO of DUT]=1), and then call the ETS function to extract the timing slack of the DUT with target timing margin slack.

In some embodiments, the function ETS (DUT, mg) defines the recursive function ETS of the DUT and its timing margin mg. When the slack of the DUT is greater than or equal to the timing margin mg (i.e., SLK_{DUT}>=mg) or the DUT has been traversed (i.e., tvl[DUT]==1), the ETS function returns. For example, the condition SLK_{DUT}>=mg indicates that the slack of the DUT is sufficient for the data path thereon, and there is no need to gain more timing slack from the DUT and/or its fan-in and fan-out devices. In some embodiments, an IC may include a plurality of DUTs, and some of them can share some common fan-in devices and/or fan-out devices, thereby establishing a plurality of data paths therebetween. When the timing analysis tool checks the overall timing slack of a first data path, a first timing slack of a first DUT on the first data path within the IC is also checked, which may be sped up by the boost function using the upsizing method or the threshold voltage up-swapping method without causing any timing and IR violations. At this time, the sped up DUT may be labeled as being traversed (i.e., tvl[DUT]==1). When the timing analysis tool checks the overall timing slack of a second data path, which shares the common DUT with the first data path, the ETS function returns because the traverse label of the DUT has been set to 1 (e.g., tvl[DUT]==1).

In some embodiments, when both the aforementioned two conditions are not met, the ETS function proceeds to perform the boost function for each and every fan-in and fan-out devices within the fan-in and fan-out cone (e.g., fan-in and fan-out hierarchy). For example, the timing slack of the fan-in devices and fan-out devices directly connected to the input ports and output ports of the DUT (e.g., at the immediate adjacent level of the DUT) are first checked. For example, the boost function may try to speed up the input device (e.g., could be the DUT or any selected cell, depending on the input device of the boost function) using the upsizing method or the threshold voltage up-swapping method to satisfy the timing margin mg without timing and IR violations, and it will label the input device as traversed (i.e., tvl[DUT]==1) when successfully speeding up the input device. It should be noted that when the boost function successfully speeds up the input device (e.g., boost (cell, mg)), the ETS function of the DUT will call the ETS function of the input device to check the timing margin of the input device (e.g., ETS (cell, mg)), as shown in Table 1.

In some embodiments, when the boost function fails to speed up the input device to meet the timing margin mg without any timing and IR violations, it will not label the input device as traversed (i.e., tvl[DUT]==0) and traverse the fan-in or fan-out devices of the input device (e.g., could be the DUT or any fan-in/fan-out device) at the immediately adjacent level. For example, the fan-in devices at the immediately adjacent level of the input device may represent the fan-in devices at the immediate preceding level, such as the fan-in device FI_{A1} at the immediately preceding level of the DUT 200 shown in FIG. 2. Additionally, the fan-out devices at the immediately adjacent level of the input device may represent the fan-out devices at the immediately succeeding level, such as the fan-out device

$${FO}_{Z 1}^{1}$$

at the immediately succeeding level of the DUT 200 shown in FIG. 2. When the boost function still fails to speed up the currently traversed fan-in or fan-out device, the boost function will keep traversing the fan-in or fan-out device at the immediately adjacent level of the currently traversed fan-in or fan-out device until no fan-in or fan-out device at the immediately adjacent level exists. The details of the ETS function will be described with reference to FIGS. 3A to 3C as follows.

FIGS. 3A to 3C are diagrams illustrating the timing slack extraction (ETS) procedure of a DUT in accordance with some embodiments of the present disclosure.

In some embodiments, the IC design 300 includes a DUT 302 and its fan-in and fan-out devices, such as FI_{A1}, FI_{A2}, and

$${FO}_{Z 1}^{1} .$$

The DUT 302 includes M input ports A1 to AM and 1 output port Z1. The input ports A1 and A2 of the DUT 302 are connected to the fan-in devices FI_{A1} and FI_{A2}, respectively, while the output port Z1 of the DUT 302 is connected to the fan-out device FO_{Z1}¹. Additionally, the fan-in device FI_{A1} has two preceding fan-in devices FI_{A1-A} and FI_{A1-B} connected thereto. For purposes of description, the DUT 302 may be an AND gate (e.g., AND_D8_LVT, which is a low threshold voltage AND gate with a eighth level of driving capability) with a slack of 2 ps and an IR value of 20%, while the fan-in device FI_{A1} may be an inverter (e.g., INV_D1_LVT, which is a low threshold voltage inverter with a first level driving capability) with a slack of 2 ps and an IR value of 2%, as depicted in FIG. 3A.

Referring to FIG. 3A, for purposes of description, the EDA tool (e.g., timing analysis tool) may set an IR threshold of 10%, indicating that any cell with an IR value exceeding 10% will cause an IR violation. Additionally, it is assumed that DUT 302 needs an additional target timing margin of 10 ps for down-sizing the DUT 302 to a smaller instance AND_D1_LVT with an IR value of 9%, which is lower than the IR threshold. This indicates that both the IR threshold (e.g., 10%) and the target timing margin (e.g., 10 ps) of the DUT 302 should be met during the ETS procedure of the DUT 302 since changing the DUT 302 from the original instance AND_D8_LVT to a new instance AND_D1_LVT will cause a −10 ps timing slack.

In operation S1, the EDA tool calls the ETS function ETS(FI_{A1}, 10) to try to extract more timing slack from the fan-in device FI_{A1} of the DUT 302 since the fan-in device FI_{A1} is the first fan-in device at the immediately preceding level of the DUT 302, as shown by FIG. 3A. Since the fan-in device FI_{A1} is not traversed yet, the boost function boost(FI_{A1}, 10) is called to extract more timing slack from the fan-in device FI_{A1}. The EDA tool may search for the candidate cells, which complies with the IR threshold of 10%, from the cell library 1044, and determines the best candidate instance (e.g., INV_D4_SVT) with the most timing slack (e.g., 8 ps) and a qualified IR value (e.g., 8%) to replace the original instance INV_D1_LVT of the fan-in device FI_{A1}. It should be noted that the newly replaced instance INV_D4_LVT can provide an additional timing slack of 8 ps, which is still lower than the target timing margin of 10 ps, and thus operation S1.1 is performed on the fan-in device FI_{A1-A} at the immediately preceding level of the fan-in device FI_{A1} by calling the ETS function ETS(FI_{A1-A}, 10). Since the fan-in device fan-in device FI_{A1-A} is not traversed yet, the EDA tool will call the boost function boost(FI_{A1-A}, 10) to gain additional timing slack from the fan-in device FI_{A1-A}. For example, the instance currently used by the fan-in device FI_{A1-A} is a standard threshold voltage (SVT) NOR gate NOR_D1_SVT, which has an IR value of 3% and a timing slack of 8 ps. Similarly, the EDA tool may search for the best candidate instance, which is a low threshold-voltage (LVT) NOR gate NOR_D1_LVT with an IR value of 5% and a timing slack of 12 ps to replace the fan-in device FI_{A1-A} from the cell library 1044, as shown by FIG. 3B. Upon successfully completing the boost function boost(FI_{A1-A}, 10), the EDA tool may recursively call the ETS function ETS(FI_{A1-A}, 10) to check the timing slack of the newly replaced fan-in device FI_{A1-A}. Accordingly, the EDA tool can find that the timing slack of the newly replaced fan-in device FI_{A1-A} meet the target timing margin of 10 ps, and determines that the boost function (FI_{A1-A}, 10) is successfully performed and the ETS function (FI_{A1-A}, 10) returns.

Furthermore, in operation S1.2, the EDA tool calls the ETS function ETS(FI_{A1-B}, 10) to try to extract more timing slack from the fan-in device FI_{A1-B} of the DUT 302 since the fan-in device FI_{A1-B} is the second fan-in device at the immediately preceding level of the fan-in device FI_{A1}, as shown by FIG. 3B. It should be noted that the original instance INV_D1_SVT of the fan-in device FI_{A1-B} has an IR value of 3% and a timing slack of 15 ps, which comply with the requirements of the IR threshold and target timing margin. Additionally, the timing slack of the fan-in device FI_{A1-B} is greater than the target timing margin (e.g., SLK>=mg), and thus the ETS(FI_{A1-B}, 10) returns. Subsequently, at operations S2 and S3, the EDA tool calls the ETS functions ETS(FI_{A2}, 10) and ETS(FO_{Z1}¹, 10) to extract additional timing margins from the fan-in device FI_{A2} and the fan-out device FO_{Z1}¹, respectively. Accordingly, the timing slack SLK of the fan-in device FI_{A2} increases to 11 ps from 9 ps, while the timing slack SLK of the fan-out device FO_{Z1}¹ increases from 2 ps to 11 ps. Specifically, the critical path of the IC design 300, which has a timing slack of 11 ps, may be from an input D flip-flop (not shown) to an output D flip-flop (not shown) through the fan-in device FI_{A2}, DUT 302, and the fan-out device FO_{Z1}¹. This indicates that the timing slack of 11 ps after the ETS procedure meets the target timing margin of 10 ps, and thus the EDA tool can replace the original instance AND_D8_LVT (e.g., with an IR value of 20% and timing slack of 2 ps) of the DUT 302 with the new instance AND_D1_LVT, which has a smaller area than the original instance AND_D8_LVT, for area optimization of the IC design 300.

FIG. 4 is a flowchart of a method for IR drop optimization of an IC design in accordance with some embodiments of the present disclosure.

At operation 402, identify the timing margin (mg) needed by a device under test (DUT) within an IC design. In some embodiments, the DUT is supposed to be the IR hotspot within the IC design, and no sufficient slack remains for IR fixing. Thus, a timing slack extraction (ETS) operation is performed on the DUT to create or gain additional timing slack, particularly from slack exhausted data paths of the IC design through the DUT.

At operation 404, boost the DUT with a target timing margin. In some embodiments, the boosting operation on the DUT within the target timing margin mg can be referred to the boosting function boost(DUT, mg). Then, at operation 406, the EDA tool determines whether the target timing margin is satisfied or the DUT has been traversed. If so, flow 400 ends. Otherwise, flow 400 proceeds to operation 408 to perform the ETS operation on the DUT within the target timing margin, i.e., ETS(DUT, mg), indicating that the EDA tool cannot replace the current used DUT using the down-sizing method or threshold-voltage up-swapping method as described above with the current timing slack of the data paths through the DUT at this time.

Then, at operation 410, the EDA tool will select a next fan-in device, and then traverse and boost a selected fan-in device FIₘ within the target timing margin (mg) (operation 412), such as performing the boosting function boost(FIₘ, mg). Here, FIₘ refers to the m-th fan-in device at the immediately preceding level of the DUT. At operation 414, the EDA tool determines whether the target timing margin is satisfied or the current fan-in device FIₘ has been traversed. If so, flow 400 returns to operation 406. Otherwise, flow 400 proceeds to operation 416 to determine whether all fan-in device have been traversed. If so, flow 400 proceeds to operation 418. Otherwise, flow 400 returns to operation 410 to select a next fan-in device. It should be noted that the recursive loop between operations 410 to 416 can be performed repeatedly until all fan-in devices of the DUT have been traversed, including fan-in devices at every preceding levels of the DUT after the input D flip-flops of the data paths through the DUT.

At operation 418, the EDA tool selects a next fan-out device FOn, and then traverse and boost the selected fan-out device FIₘ within the target timing margin (mg) (operation 420), such as performing the boosting function boost(FOₙ, mg). Here, FOₙ refers to the n-th fan-out device at the immediately succeeding level of the DUT. At operation 420, the EDA tool determines whether the target timing margin is satisfied or the current fan-out device FOₙ has been traversed. If so, flow 400 returns to operation 406. Otherwise, flow 400 proceeds to operation 422 to determine whether all fan-out device have been traversed. If so, flow 400 ends. Otherwise, flow 400 returns to operation 418 to select a next fan-out device. It should be noted that the recursive loop between operations 418 to 422 can be performed repeatedly until all fan-out devices of the DUT have been traversed, including fan-out devices at every succeeding levels of the DUT before the output D flip-flops of the data paths through the DUT.

More specifically, when the EDA tool fails to boost the selected fan-in or fan-out device due to timing or IR violations, a recursive call of the ETS function is needed. Additionally, a maximum timing slack can be extracted for the DUT by traversing all fan-in and fan-out devices of the DUT with the ETS and boost operations. Furthermore, after the additional timing slack is extracted for the DUT, the EDA tool may try to replace the current instance of the DUT with another instance with a smaller size or a higher threshold voltage for area optimization of the IC design.

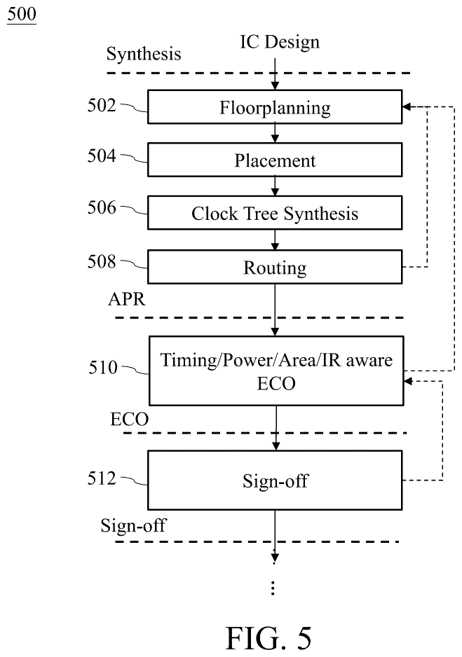

FIG. 5 is a flowchart of a backend IC design flow in accordance with some embodiments of the present disclosure.

In integrated circuit (IC) design, a variety of functions are integrated into one chip, and an application specific integrated circuit (ASIC) or system on a chip (SOC) cell based design is often used. In this approach, a library of known functions is provided, and after the functional design of the device is specified by choosing and connecting these standard functions, and proper operation of the resulting circuit is verified using electronic design automation (EDA) tools, the library elements are mapped on to predefined layout cells, which contain prefigured elements such as transistors. The cells are chosen with the particular semiconductor process nodes and parameters in mind and create a process-parameterized physical representation of the design. The design flow continues from that point by performing placement and routing of the local and global connections needed to form a layout of the completed design using the standard cells.

For example, at floorplanning stage 502, the APR tool identifies circuit elements and/or standard cells, which are to be electrically connected to each other and which are to be placed in close proximity to each other, for reducing the area of the IC and/or reducing time delays of signals travelling over the interconnections or nets connecting the electrically connected circuit elements. At placement stage 504, the APR tool performs cell placement. For example, standard cells configured to provide pre-defined functions and having pre-designed layout diagrams are stored in cell library 1044. The APR tool accesses various standard cells from cell library 1044, and places these standard cells in an abutting manner to generate an IC layout diagram corresponding to the IC schematic.

At clock tree synthesis (CTS) stage 506, the APR tool performs clock tree synthesis to minimize clock skews and/or delays potentially present due to the placement of standard cells in the IC layout diagram. The clock tree synthesis may include an optimization process to ensure that signals are transmitted and/or arrived at appropriate timing. For example, during the optimization process within the clock tree synthesis, the APR tool may insert one or more vias into the IC layout diagram to add and/or remove slack (timing for signal arrival) and/or insert one or more clock buffers into the IC layout diagram to achieve desired clock timing. Accordingly, the IC layout diagram is updated by clock tree synthesis operation 506.

At routing stage 508, the APR tool performs routing to route various nets (e.g., conductive wires) interconnecting the placed standard cells. The routing is performed to ensure that the routed interconnections or nets satisfy a set of constraints. For example, routing stage 508 includes global routing, track assignment and detailed routing. During the global routing, routing resources used for interconnections or nets are allocated. For example, the routing area is divided into a number of sub-areas, pins of the placed standard cells are mapped to the sub-areas, and nets are constructed as sets of sub-areas in which interconnections are physically routable. During the track assignment, the APR tool assigns interconnections or nets to corresponding conductive layers of the IC layout diagram. During the detailed routing, the APR tool routes interconnections or nets in the assigned conductive layers and within the global routing resources. For example, detailed physical interconnections are generated within the corresponding sets of sub-areas defined at the global routing and in the conductive layers defined at the track assignment. After routing stage 508, the APR tool outputs the IC layout diagram including the power grid structure, placed standard cells and routed nets. The described APR tool is an example. Other arrangements are within the scope of various embodiments. For example, in one or more embodiments, one or more of the described operations are omitted.

In some embodiments, the ECO (engineering change order) stage 510 during the ECO flow may perform on the IC layout diagram for timing, power, area, and/or IR issues by the designers manually or by the EDA tool automatically.

It should be noted that replacing the instance of the DUT, as described in the embodiments of FIGS. 3 to 4, can be performed within the routing stage 508 within the APR flow or the ECO stage 510 (e.g., for timing/power/area/IR aware ECO) immediately after the APR flow since the IC layout diagram includes more practical timing information with regard to routing wires. Upon completion of the replacing operation, the backend IC design flow of the IC design goes back to the floorplanning stage 502, which is the beginning stage of the APR flow. This indicates that the APR flow is re-executed to ensure the new layout of the IC design satisfies the timing and IR requirements. Additionally, the down-sizing method and threshold-voltage up-swapping method are still effective after the additional timing slack is created by the ETS operation of the DUT. Accordingly, the manual efforts to dig out use slack among the whole IC design can be significantly reduced using the proposed method. The proposed timing slack extraction method is not only IR-aware but also timing-aware and physical-aware.

In some embodiments, the sign-off stage 512 during the sign-off flow can be regarded as a post-routing optimization operation. At post-routing optimization operation 225, one or more physical and/or timing verifications are performed. For example, the sign-off stage 512 includes one or more of a resistance and capacitance (RC) extraction, a layout-versus-schematic (LVS) check, a design rule check (DRC), electric rule check (ERC), and a timing sign-off check (also referred to as a post-layout simulation). Other verification processes are usable in other embodiments. The DRC is a process of checking whether the layout is successfully completed with a physical measure space according to the design rule, and the LVS is a process of checking whether the layout meets a corresponding circuit diagram. In addition, the ERC is a process of for checking whether devices and wires/nets are electrically well connected therebetween. After design rule checks, design rule verification, timing analysis, critical path analysis, static and dynamic power analysis, and final modifications to the design, a tape out process is performed to produce photomask generation data. This photomask generation (PG) data is then used to create the optical masks used to fabricate the semiconductor device in a photolithographic process at a wafer fabrication facility (FAB). In the tape out process, the database file of the IC is used to make various layers of masks for integrated circuit manufacturing. In some embodiments, the database file is a Graphic Database System (GDS) file (e.g., a GDS file or a GDSII file). Furthermore, the GDS file is the industry's standard format for transfer of IC layout data between design tools of different vendors.

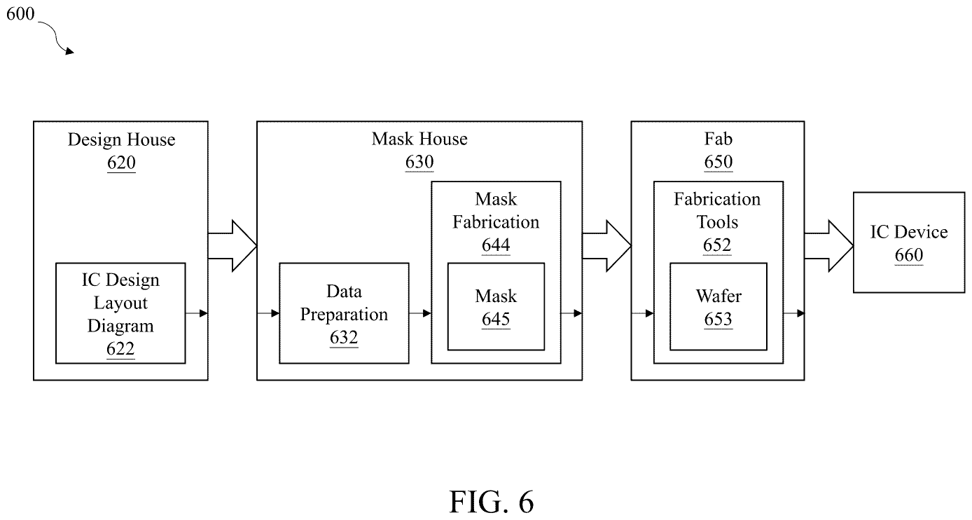

FIG. 6 is a block diagram of an IC manufacturing system 600, and an IC manufacturing flow associated therewith, in accordance with some embodiments. In some embodiments, based on an IC layout diagram, at least one of (A) one or more semiconductor masks or (B) at least one component in a layer of a semiconductor integrated circuit is fabricated using manufacturing system 600.

In FIG. 6, IC manufacturing system 600 includes entities, such as a design house 620, a mask house 630, and an IC manufacturer/fabricator (“fab”) 650, that interact with one another in the design, development, and manufacturing cycles and/or services related to manufacturing an IC device 660. The entities in system 600 are connected by a communications network. In some embodiments, the communications network is a single network. In some embodiments, the communications network is a variety of different networks, such as an intranet and the Internet. The communications network includes wired and/or wireless communication channels. Each entity interacts with one or more of the other entities and provides services to and/or receives services from one or more of the other entities. In some embodiments, two or more of design house 620, mask house 630, and IC fab 650 is owned by a single larger company. In some embodiments, two or more of design house 620, mask house 630, and IC fab 650 coexist in a common facility and use common resources.

The design house (or design team) 620 generates an IC design layout diagram 622, which is obtained using schematics of electrical devices that utilize a smaller technology node migrated from a larger technology node, employing the methods described in the embodiments of FIGS. 3 to 4. IC design layout diagram 622 includes various geometrical patterns, such as the IC layout diagram discussed above. These geometrical patterns correspond to patterns of metal, oxide, or semiconductor layers that constitute the various components of IC device 660 to be fabricated. The various layers combine to form different IC features. For example, a portion of IC design layout diagram 622 includes various IC features, such as an active region, gate electrode, source and drain, metal lines or vias of an interlayer interconnection, and openings for bonding pads, to be formed in a semiconductor substrate (such as a silicon wafer) and various material layers disposed on the semiconductor substrate. Design house 620 implements an appropriate design procedure to form IC design layout diagram 622. The design procedure includes one or more of logic design, physical design, or place and route. IC design layout diagram 622 is presented in one or more data files containing information about the geometrical patterns. For example, IC design layout diagram 622 can be expressed in a GDSII file format or DFII file format.

Mask house 630 includes data preparation 632 and mask fabrication 644. Mask house 630 uses IC design layout diagram 622 to manufacture one or more masks 645 to be used for fabricating the various layers of IC device 660 according to IC design layout diagram 622. Mask house 630 performs mask data preparation 632, where IC design layout diagram 622 is translated into a representative data file (RDF). Mask data preparation 632 provides the RDF to mask fabrication 644. Mask fabrication 644 includes a mask writer. A mask writer converts the RDF to an image on a substrate, such as mask (reticle) 645 or a semiconductor wafer 653. The design layout diagram 622 is manipulated by mask data preparation 632 to comply with particular characteristics of the mask writer and/or requirements of IC fab 650. In FIG. 6, mask data preparation 632 and mask fabrication 644 are illustrated as separate elements. In some embodiments, mask data preparation 632 and mask fabrication 644 can be collectively referred to as mask data preparation.

In some embodiments, mask data preparation 632 includes optical proximity correction (OPC) which uses lithography enhancement techniques to compensate for image errors, such as those that can arise from diffraction, interference, other process effects and the like. OPC adjusts IC design layout diagram 622. In some embodiments, mask data preparation 632 includes further resolution enhancement techniques (RET), such as off-axis illumination, sub-resolution assist features, phase-shifting masks, other suitable techniques, and the like or combinations thereof. In some embodiments, inverse lithography technology (ILT) is also used, which treats OPC as an inverse imaging problem.

In some embodiments, mask data preparation 632 includes a mask rule checker (MRC) that checks the IC design layout diagram 622 that has undergone processes in OPC with a set of mask creation rules which contain certain geometric and/or connectivity restrictions to ensure sufficient margins, to account for variability in semiconductor manufacturing processes, and the like. In some embodiments, the MRC modifies the IC design layout diagram 622 to compensate for limitations during mask fabrication 644, which may undo part of the modifications performed by OPC in order to meet mask creation rules.

In some embodiments, mask data preparation 632 includes lithography process checking (LPC) that simulates processing that will be implemented by IC fab 650 to fabricate IC device 660. LPC simulates this processing based on IC design layout diagram 622 to create a simulated manufactured device, such as IC device 660. The processing parameters in LPC simulation can include parameters associated with various processes of the IC manufacturing cycle, parameters associated with tools used for manufacturing the IC, and/or other aspects of the manufacturing process. LPC takes into account various factors, such as aerial image contrast, depth of focus (“DOF”), mask error enhancement factor (“MEEF”), other suitable factors, and the like or combinations thereof. In some embodiments, after a simulated manufactured device has been created by LPC, if the simulated device is not close enough in shape to satisfy design rules, OPC and/or MRC are be repeated to further refine IC design layout diagram 622.

It should be understood that the above description of mask data preparation 632 has been simplified for the purposes of clarity. In some embodiments, data preparation 632 includes additional features such as a logic operation (LOP) to modify the IC design layout diagram 622 according to manufacturing rules. Additionally, the processes applied to IC design layout diagram 622 during data preparation 632 may be executed in a variety of different orders.

After mask data preparation 632 and during mask fabrication 644, a mask 645 or a group of masks 645 are fabricated based on the modified IC design layout diagram 622. In some embodiments, mask fabrication 644 includes performing one or more lithographic exposures based on IC design layout diagram 622. In some embodiments, an electron-beam (e-beam) or a mechanism of multiple e-beams is used to form a pattern on a mask (photomask or reticle) 645 based on the modified IC design layout diagram 622. Mask 645 can be formed in various technologies. In some embodiments, mask 645 is formed using binary technology. In some embodiments, a mask pattern includes opaque regions and transparent regions. A radiation beam, such as an ultraviolet (UV) or EUV beam, used to expose the image sensitive material layer (e.g., photoresist) which has been coated on a wafer, is blocked by the opaque region and transmits through the transparent regions. In one example, a binary mask version of mask 645 includes a transparent substrate (e.g., fused quartz) and an opaque material (e.g., chromium) coated in the opaque regions of the binary mask. In another example, mask 645 is formed using a phase shift technology. In a phase shift mask (PSM) version of mask 645, various features in the pattern formed on the phase shift mask are configured to have proper phase difference to enhance the resolution and imaging quality. In various examples, the phase shift mask can be attenuated PSM or alternating PSM. The mask(s) generated by mask fabrication 644 is used in a variety of processes. For example, such a mask(s) is used in an ion implantation process to form various doped regions in semiconductor wafer 653, in an etching process to form various etching regions in semiconductor wafer 653, and/or in other suitable processes.

IC fab 650 is an IC fabrication business that includes one or more manufacturing facilities for the fabrication of a variety of different IC products. In some embodiments, IC Fab 650 is a semiconductor foundry. For example, there may be a manufacturing facility for the front end fabrication of a plurality of IC products (front-end-of-line (FEOL) fabrication), while a second manufacturing facility may provide the back end fabrication for the interconnection and packaging of the IC products (back-end-of-line (BEOL) fabrication), and a third manufacturing facility may provide other services for the foundry business.

IC fab 650 includes wafer fabrication tools 652 configured to execute various manufacturing operations on semiconductor wafer 653 such that IC device 660 is fabricated in accordance with the mask(s), e.g., mask 645. In various embodiments, fabrication tools 652 include one or more of a wafer stepper, an ion implanter, a photoresist coater, a process chamber, e.g., a CVD chamber or LPCVD furnace, a CMP system, a plasma etch system, a wafer cleaning system, or other manufacturing equipment capable of performing one or more suitable manufacturing processes as discussed herein.

IC fab 650 uses mask(s) 645 fabricated by mask house 630 to fabricate IC device 660. Thus, IC fab 650 at least indirectly uses IC design layout diagram 622 to fabricate IC device 660. In some embodiments, semiconductor wafer 653 is fabricated by IC fab 650 using mask(s) 645 to form IC device 660. In some embodiments, the IC fabrication includes performing one or more lithographic exposures based at least indirectly on IC design layout diagram 622. Semiconductor wafer 653 includes a silicon substrate or other proper substrate having material layers formed thereon. Semiconductor wafer 653 further includes one or more of various doped regions, dielectric features, multilevel interconnects, and the like (formed at subsequent manufacturing steps).

An aspect of the present disclosure provides a method. The method includes the following steps: identifying a target timing margin needed by a device under test (DUT) within an integrated circuit (IC) design, wherein the DUT comprises one or more fan-in devices and one or more fan-out devices connected thereto; in response to the DUT being unable to be boosted to reduce a timing slack thereof, performing a timing slack extraction operation on the one or more fan-in devices and the one or more fan-out devices of the DUT; in response to a boosting operation of a selected device of the one or more fan-in devices and the one or more fan-out devices being successfully performed, updating an IC layout diagram of the IC design by replacing a first instance with a first timing slack currently used by the selected device with a second instance with a second timing slack, wherein the second timing slack is greater than the first timing slack; and repeatedly performing the timing slack extraction operation on the one or more fan-in devices and the one or more fan-out devices of the DUT until the target timing margin is met.

Another aspect of the present disclosure provides a system which includes a non-transitory computer-readable medium storing program instructions and a processor. The non-transitory computer-readable medium includes program instructions. The processor is operatively coupled to the non-transitory computer-readable medium. The program instructions, when executed by the processor, cause the processor to perform a method. The method includes the following steps: identifying a target timing margin needed by a device under test (DUT) within an integrated circuit (IC) design; in response to a first timing slack of the DUT failing to meet the target timing margin, traversing one or more fan-in devices and one or more fan-out devices of the DUT to increase the timing slack of the DUT; and repeatedly performing a timing slack extraction operation on the one or more fan-in devices and the one or more fan-out devices of the DUT until an overall timing slack of each data path through the DUT meets the target timing margin.

Yet another aspect of the present disclosure provides a system which includes a non-transitory computer-readable medium storing program instructions and a processor. The non-transitory computer-readable medium includes program instructions. The processor is operatively coupled to the non-transitory computer-readable medium. The program instructions, when executed by the processor, cause the processor to perform a method. The method includes the following steps: identifying a target timing margin needed by a device under test (DUT) within an integrated circuit (IC) design; in response to a first timing slack of the DUT failing to meet the target timing margin, traverse one or more fan-in devices and one or more fan-out devices of the DUT; and improving an overall timing slack on each data path through the DUT by replacing a first instance having a first timing slack used by a device selected from the one or more fan-in devices and the one or more fan-out devices with a second instance having a second timing slack, wherein the second timing slack is greater than the first timing slack; repeatedly performing a timing slack extraction operation on the one or more fan-in devices and the one or more fan-out devices of the DUT until the overall timing slack of each data path through the DUT meets the target timing margin.

The methods and features of the present disclosure have been sufficiently described in the provided examples and descriptions. It should be understood that any modifications or changes without departing from the spirit of the present disclosure are intended to be covered in the protection scope of the present disclosure.

Moreover, the scope of the present application is not intended to be limited to the particular embodiments of the process, machine, manufacture, and composition of matter, means, methods and steps described in the specification. As those skilled in the art will readily appreciate from the present disclosure, processes, machines, manufacture, composition of matter, means, methods or steps presently existing or later to be developed, that perform substantially the same function or achieve substantially the same result as the corresponding embodiments described herein, can be utilized according to the present disclosure.

Accordingly, the appended claims are intended to include within their scope processes, machines, manufacture, compositions of matter, means, methods or steps. In addition, each claim constitutes a separate embodiment, and the combination of various claims and embodiments are within the scope of the present disclosure.

What is claimed is:

1. A method, comprising:
identifying, by a processor, a target timing margin needed by a device under test (DUT) within an integrated circuit (IC) design, wherein the DUT comprises one or more fan-in devices and one or more fan-out devices connected thereto;
in response to the DUT being unable to be boosted to reduce a timing slack thereof, performing, by the processor, a timing slack extraction operation on the one or more fan-in devices and the one or more fan-out devices of the DUT;
in response to a boosting operation of a selected device of the one or more fan-in devices and the one or more fan-out devices being successfully performed, updating, by the processor, an IC layout diagram of the IC design by replacing a first instance with a first timing slack currently used by the selected device with a second instance with a second timing slack, wherein the second timing slack is greater than the first timing slack; and
repeatedly performing, by the processor, the timing slack extraction operation on the one or more fan-in devices and the one or more fan-out devices of the DUT until the target timing margin is met.

2. The method of claim 1, wherein the timing slack of the DUT is initially greater than the target timing margin.

3. The method of claim 2, wherein the one or more fan-in devices are connected to one or more input ports of the DUT, and the one or more fan-out devices are connected to one or more output ports of the DUT.

4. The method of claim 3, wherein the one or more fan-in devices are arranged in one or more levels preceding to the input ports of the DUT, and the one or more fan-out devices are arranged in one or more levels succeeding to the output ports of the DUT.

5. The method of claim 1, further comprising:
setting, by the processor, an IR (current-resistance) threshold for the IC design;
searching, by the processor, for one or more candidate instances from a cell library which are equivalent to the first instance of the selected device; and
determining one of the one or more candidate instances, which has a greatest timing slack and satisfies the IR threshold as the selected device.

6. The method of claim 5, wherein the second instance has a greater transistor size than the first instance.

7. The method of claim 6, wherein a transistor size comprises a channel width, a number of fins, or a number of channels when the first instance and the second instance are planar field-effect transistors (FET), finFETs, or nanosheet FETs.

8. The method of claim 5, wherein the second instance has a lower threshold voltage than the first instance.

9. The method of claim 1, further comprising: performing the timing slack extraction operation on a first fan-in device, which is at an immediately preceding level of the DUT, among the one or more fan-in devices.

10. The method of claim 9, further comprising: upon the boosting operation of the first fan-in device being unsuccessful, traversing and performing another boosting operation on one or more fan-in devices at an immediately preceding level of the first fan-in device.

11. The method of claim 1, further comprising: upon the one or more fan-in devices being traversed, performing the timing slack extraction operation on a first fan-out device, which is at an immediately succeeding level of the DUT, among the one or more fan-out devices.

12. The method of claim 11, further comprising: upon the boosting operation of the first fan-out device being unsuccessful, traversing and performing another boosting operation on the one or more fan-out devices at an immediately succeeding level of the first fan-out device.

13. The method of claim 1, further comprising:
in response to the target timing margin being met, searching, by the processor, for one or more candidate instances from a cell library which are equivalent to the DUT; and
determining, by the processor, one of the one or more candidate instances, which has an IR value lower than a predetermined IR threshold of the DUT; and
replacing a third instance currently used by the DUT with the determined candidate instance.

14. The method of claim 13, wherein the determined candidate instance has a smaller area than the third instance.

15. The method of claim 13, wherein the determined candidate instance has a higher threshold voltage than the third instance.

16. A system comprising a non-transitory computer-readable medium storing program instructions; and a processor operatively coupled to the non-transitory computer-readable medium, wherein the program instructions, when executed by the processor, cause the processor to perform the following operations:
identify a target timing margin needed by a device under test (DUT) within an integrated circuit (IC) design;
in response to a first timing slack of the DUT failing to meet the target timing margin, traverse one or more fan-in devices and one or more fan-out devices of the DUT to increase the first timing slack of the DUT; and
repeatedly perform a timing slack extraction operation on the one or more fan-in devices and the one or more fan-out devices of the DUT until an overall timing slack of each data path through the DUT meets the target timing margin.

17. The system of claim 16, wherein the processor further performs:
set an IR (current-resistance) threshold for the IC design;
in response to the target timing margin being met, search for one or more candidate instances from a cell library which are equivalent to a first instance used by the DUT; and
determining a candidate instance from a cell library, which is equivalent to the first instance and has an IR value lower than the IR threshold; and
replacing the first instance used by the DUT with the determined candidate instance.

18. The system of claim 17, wherein the determined candidate instance has a smaller area or a higher threshold voltage than the first instance.

19. A system comprising a non-transitory computer-readable medium storing program instructions; and a processor operatively coupled to the non-transitory computer-readable medium, wherein the program instructions, when executed by the processor, cause the processor to perform:
identify a target timing margin needed by a device under test (DUT) within an integrated circuit (IC) design;
in response to a first timing slack of the DUT failing to meet the target timing margin, traverse one or more fan-in devices and one or more fan-out devices of the DUT;
improve an overall timing slack on each data path through the DUT by replacing a first instance having a first timing slack used by a device selected from the one or more fan-in devices and the one or more fan-out devices with a second instance having a second timing slack, wherein the second timing slack is greater than the first timing slack; and
repeatedly perform a timing slack extraction operation on the one or more fan-in devices and the one or more fan-out devices of the DUT until the overall timing slack of each data path through the DUT meets the target timing margin.

20. The system of claim 19, wherein an IR value of the second instance is lower than a predetermined IR threshold of the IC design.
